(19) United States
(12) Patent Application Publication
(10) Pub. No.: US 2025/0153448 A1
(43) Pub. Date: May 15, 2025

(54) A MOULD TOOL

(71) Applicant: INVIBIO DEVICE COMPONENT MANUFACTURING LIMITED, Thornton Cleveleys, Lancashire (GB)

(72) Inventors: Robert Baylis, Thornton Cleveleys, Lancashire (GB); Stephen Bonham, Thornton Cleveleys, Lancashire (GB); Michael Burgess, Thornton Cleveleys, Lancashire (GB)

(21) Appl. No.: 18/728,654

(22) PCT Filed: Dec. 20, 2022
(86) PCT No.: PCT/GB2022/053323

§ 371 Date: Jul. 12, 2024

(30) Foreign Application Priority Data
Jan. 14, 2022 (GB) 2200455.0

(51) Int. Cl. B29C 70/46; B29K 71/00; B29K 307/04

(52) U.S. Cl. CPC B29C 70/46; B29K 2071/00; B29K 2307/04

(57) ABSTRACT

A mould tool and a method of manufacturing for forming a compression moulded body from a plurality of stacked layers of polymer material. The mould tool comprises a first section and a top section. The first section has a mould opening defined by a side wall and configured to receive the stacked layers. The top section is configured to close the mould opening to form a mould cavity. The moulding opening side wall includes at least one recess to accommodate polymer material from the stacked layers when the stacked layers are compressed by movement of the top section towards the first section.

### TECHNICAL FIELD

The present invention relates to a mould tool. The present invention further relates to a method of using the mould tool to manufacture a compression moulded body from a plurality of stacked layers of polymer material. Certain examples of the present invention relate to a mould tool that may be used to manufacture a bone fracture plate.

### BACKGROUND

It is known to manufacturing parts by compression moulding a plurality of layers of a polymer material. The end result may be referred to as a laminate structure. Typically each layer (also referred to as a laminate or ply) may comprise a composite material comprising a polymer and reinforcement fibres. An example of such a composite material comprises carbon fibre and polyaryletherketone (PAEK). The polyaryletherketone may comprises polyetheretherketone (PEEK).

Polymer compression moulding may be used in a range of applications to form laminated products, including, for example, in the manufacture of medical devices. For example, a bone fracture plate may be formed by compression moulding a plurality of layers of polymer (with or without reinforcement fibres). Conventionally, a mould tool is used having a mould cavity defining a shape of a blank part. The mould cavity is then filled with layers that are cut or otherwise shaped to fill the mould cavity, the mould cavity is closed off and the mould cavity is compressed and heated to form a compression moulded blank. Typically, the edges of the moulded blank are then machined down to a nominal (intended) part size for the final product. There may be further post-moulding processes. For instance, in the case of a bone fracture plate, screw holes may be milled through the plate. In the present specification bone fracture plates are presented as an example of compression moulded body, however the present invention is not limited to this. The skilled person will understand that that same compression moulding process may be used to form parts in a wide range of industries including the automotive and aerospace sectors.

Conventional mould tools are designed to minimise the occurrence of voids in the moulded body. A void in a moulded body can be a cause of later failure of that part. As described in greater detail below, a floating mould tool may be used such that all compressive force is applied to the stacked polymer layers without the mould tool bottoming out. This is achieved by filling the mould cavity with a greater thickness of layers that is required to ensure that the mould tool does not bottom out even at the point of maximum compression. However, while a floating mould tool addresses the problem of voids, this requirement to overfill the mould cavity results in limited control over the thickness of the moulded part, particularly in the event of variable thickness of each stacked layer. Variation in part thickness may be particularly disadvantageous for a compression moulded bone fracture plate within which screw holes are milled: thickness variation may disrupt the fit of bone screws intended to lock to the plate, especially for tapered screws.

It is an aim of certain examples of the present invention to solve, mitigate or obviate, at least partly, at least one of the problems and/or disadvantages associated with the prior art. Particularly, certain examples of the present invention aim to provide a mould tool which allows greater control over the thickness of a compression moulded part while also minimising the occurrence of voids.

### BRIEF SUMMARY OF THE INVENTION

According to a first example of the present invention there is provided a mould tool for forming a compression moulded body from a plurality of stacked layers of polymer material, the mould tool comprising: a first section having a mould opening defined by a side wall and configured to receive the stacked layers; and a top section configured to close the mould opening to form a mould cavity; wherein the moulding opening side wall includes at least one recess to accommodate polymer material from the stacked layers when the stacked layers are compressed by movement of the top section towards the first section.

The mould tool may be designed to bottom out at the limit of compression. That is, further compression is restricted by portions of the first and top section coming to bear against one another. While for a conventional floating mould tool bottoming out risks the occurrence of voids, for the mould tool of the present invention voids are minimised or avoided altogether by filling the mould cavity with a sufficient number of layers of polymer material such that there is a slight excess of material. Compression applied to the stacked layers causes a portion of the polymer in one or more layers to flow or transfer to the side of the mould cavity where this excess material is accommodated in one or more recess. As the mould tool bottoms out, the thickness of the moulded body is accurately determined by the dimensions of the mould cavity. Excess polymer material within the recess may be readily machined off the sides of the moulded body (it already being conventional to mould an oversize blank part and then machined down the edges to a nominal part size).

The first section may comprise a middle section and a bottom section. That is, the mould tool may be in three parts: top, middle and bottom sections. The mould opening may extend through the middle section. The top section may be configured to close off a first end of the mould opening. The top section may comprise a protrusion shaped to be received in the opening. The bottom section may be configured to close off a second end of the mould opening to form the mould cavity. The bottom section may comprise a protrusion shaped to be received in the mould opening. Alternatively, the mould took may be a two-part mould tool, for which the middle and bottom sections are integrally formed.

The mould cavity may be tapered by providing a tapered side wall to the mould opening in the middle section such that it widens towards the first end of the mould opening. The protrusion of the top section may have a corresponding taper. Alternatively, only the portion of the mould opening side wall that defines the sides of the mould cavity may be tapered. This tapering makes it easier to remove the moulded body from the mould cavity. For a three-part mould tool an ejector part may also be provided. The ejector is generally similar to the bottom section however the protrusion is taller such that when swapped for the bottom section the ejector pushes the moulded body from the mould opening. For a two-part mould tool ejector pins may be used with corresponding holes in the first section. The lower part of the mould opening corresponding to the bottom section protrusion (for a two-part mould tool) may not be tapered or may taper in the opposite direction (widening towards the second end of the mould opening.

The recess may extend along the side wall along the height of the mould cavity. In some examples at least one recess may not extend along the full height of the mould cavity. The recess may comprise a scallop formed in the side wall. The shape of each recess may vary widely even within a single mould tool. Advantageously, the recesses may collectively provide a sufficient volume to accommodate the polymer material pressed out from the stacked layers.

The side wall may comprise a plurality of spaced apart recesses. They may be evenly distributed or distributed according to predicted displacement of polymer material during compression moulding. A greater number of recesses may be distributed in regions of the side wall where the mould cavity is taller. Recesses may be particularly located where there is a thickness variation in the mould cavity. The mould cavity may have any shape by defining edges of the of moulded body through the side wall of the mould opening and by defining top and bottom surfaces of the moulded body through the protrusions of the top and bottom sections of the mould tool (of the base of the mould opening in the case of a two-part mould tool).

The first section may include at least one slot in an upper surface facing a portion of the top section and arranged to receive a first spacer element such that the first spacer element protrudes above the upper surface and movement of the top section towards the first section is limited and the height of the mould cavity is increased. This allows a single mould tool to be used to manufacture moulded bodies with different thicknesses. This is not achievable with conventional floating mould tools. It will be appreciated that the number of layers of polymer material required may vary according to the intended thickness of the moulded body.

The mould tool may further comprise a second spacer element arranged to be received in the mould opening such that the height of the mould cavity is reduced. Again, this permits moulded bodies with different thicknesses (in this case, thinner) to be manufactured. Advantageously, the present invention permits a range of different end products to be moulded using a single mould tool. For the example of a bone fracture plate, this may correspond to plates of similar dimensions except for thickness which is variable according to the required strength (based on clinical indications).

In some examples the depth of the mould cavity may not be uniform in order to manufacture moulded bodies with thickness variations. It may be necessary to pack the mould cavity with a greater number of layers in intended thicker regions.

According to a second example of the present invention there is provided a method of manufacturing a compression moulded body, the method comprising: providing a mould tool as described above; forming a plurality of layers of polymer material; stacking the plurality of layers within the mould opening; closing the mould opening with the top section; and compressing the mould tool such that the top section moves towards the first section of the mould tool to compression mould the stacked plurality of layers within the mould cavity.

The number of layers of polymer material may be selected such that for a given mould cavity depth a slightly greater thickness of pre-compressed layers is provided. Accordingly, upon compression of the mould tool, the layers are compressed resulting in a portion of the polymer material flowing to the edges of the mould cavity where it flows into one or more recess. This flow of polymer and compression of the layers reduces the incidence of voids in the moulded body. The maximum compression applied to the moulded body (at the time of mould tool bottoming out) is dependent upon the selection of the number of layers relative to the depth of the mould cavity. The skilled person will appreciate that this may be determined through knowledge of the thickness of each layer (and any thickness variation), the depth of the mould cavity, and the compressive properties of the materials of each layer.

Movement of the top section towards the first section may be limited by part of the top section bearing against part of the first section.

The method may further comprise heating the mould cavity.

The side wall of the mould opening, other than the recess, may bear against portions of the plurality of layers to keep the stacked layers aligned within the mould cavity. It may be that the recesses form a minority of the side wall of the mould opening such that the effect of the mould opening in aligning stacked layers is not materially different to that for a conventional mould tool. In some examples the proportion of recess and non-recess in the side wall may be comparable. In some examples the recesses may define a majority of the side wall.

The method may further comprise removing the compression moulded body from the mould cavity and cutting away one or more edge parts corresponding to a recess. Further conventional post-moulding processes such as milling holes may be performed. In some cases a mould tool according to an example of the present invention may be used to mould a large blank from which a plurality of parts may be cut.

The polymer may be polyaryletherketone. The polyaryletherketone may be polyetheretherketone, PEEK. The plurality of layers may further include a reinforcement fibre. The reinforcement fibre may be carbon fibre.

### BRIEF DESCRIPTION OF THE DRAWINGS

Examples of the invention are further described hereinafter with reference to the accompanying drawings, in which:

FIG. 1 is a schematic drawing of a lay-up arrangement that may be used in the manufacture of a compression moulded body;

FIG. 2 is a flow chart illustrating a method of manufacturing of a compression moulded body;

FIGS. 3a to 3g show different steps in the method of manufacturing of FIG. 2;

FIG. 4 is an exploded perspective view of a mould tool according to the prior art;

FIG. 5 is a partially transparent perspective view of the mould tool of FIG. 4;

FIG. 6 is a side view of the mould tool of FIG. 4;

FIG. 7 is a plan view of part of the mould tool of FIG. 4;

FIG. 8 is a perspective view of a blank manufactured using the mould tool of FIG. 4;

FIG. 9 is an exploded perspective view of a mould tool according to an example of the present invention;

FIG. 10 is a perspective view of the mould tool of FIG. 9; and

FIG. 11 is a plan view of part of the mould tool of FIG. 9.

### DETAILED DESCRIPTION

The present invention relates to a mould tool and a method of manufacturing a compression moulded body using the mould tool.

The compression moulded body is formed from a plurality of layers of polymer. In certain non-limiting examples the layers may be formed from a composite material. The composite material forming the layers may be provided in the form of a tape. Layers (also referred to as “plies” or “laminates”) may be formed of joined portions of tape. The composite material may comprise polyaryletherketone as an example polymer and reinforcement fibre, for instance carbon fibre. The polyaryletherketone may suitably be polyetheretherketone (PEEK). Greater detail regarding these materials is given in the description below.

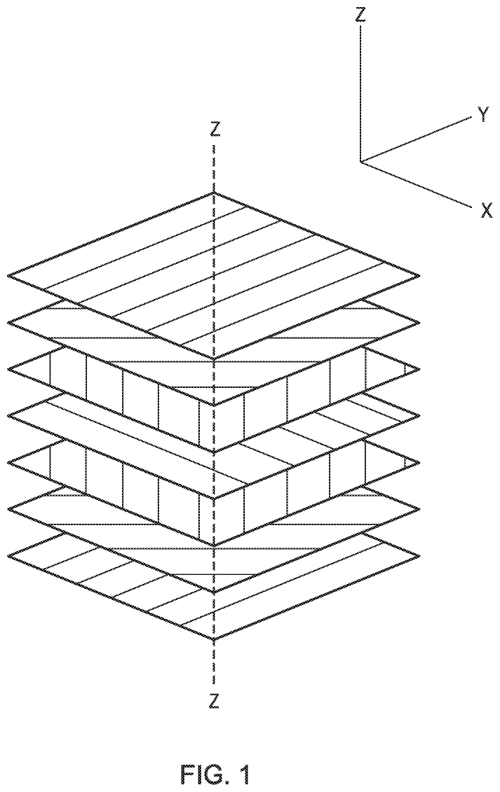

Referring to FIG. 1, this is a schematic drawing of an example lay-up arrangement of layers of tape that may be compression moulded using a mould tool according to an example of the present invention to form a compression moulded body. The layers are stacked into a mould cavity in the Z direction, each layer comprising a composite tape layer (or ply) having varying orientations of carbon fibres in an X-Y plane. Starting from the bottom of the lay-up as shown, the first layer is formed of tape that is unidirectionally aligned along the Y-axis (0°). The second layer is formed of tape that is unidirectionally aligned at 45° to the axis of the first layer. The third layer is formed of tape 14c that is unidirectionally aligned at −45° to the axis of the first layer. The fourth layer is formed of tape 14d that is unidirectionally aligned at 90° to the axis of the first layer (that is, along the X-axis). The pattern is repeated so that the overall structure has the following alignment: 0°, 45°, −45°, 90°, −45°, 45° and 0. The resulting laminate may be compression moulded under heat and pressure to form a compression moulded semi-finished component—a blank. Additional features such as holes can then be machined into the blank and edge regions of the blank machined to size to form a finished compression moulded body.

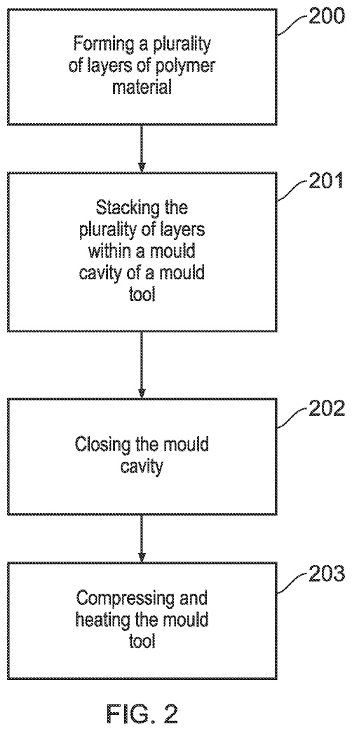

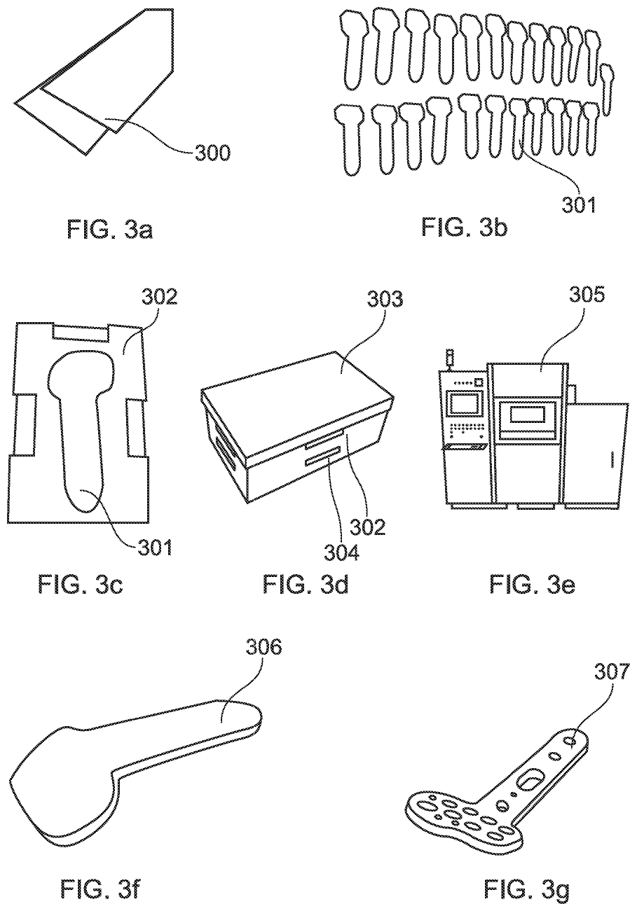

Referring now to FIGS. 2 and 3a to 3g a method of manufacturing a compression moulded body will now be described. The method is applicable to conventional floating mould tools and mould tools according to examples of the present invention, as will be apparent from the description of the later figures.

The method begins at step 200 with the formation of a plurality of layers of polymer material. As noted previously, this may suitably comprise a composite material including a polymer and reinforcement fibres. This may be provided as a tape 300 as shown in FIG. 3a. The tape 300 may be cut or otherwise shaped to form a plurality of layers 301 (also referred to as plies) as shown in FIG. 3b. It can be seen that in this example each layer 301 is substantially the same shape. In other examples the shapes may vary through at least part of the stack, for instance where there are thickness variations. Two or more pieces of tape 300 may be joined to form layers 301, if required.

At step 201 the plurality of layers 301 are stacked within a mould cavity of a middle section 302 of a mould tool as shown in FIG. 3c. This may be referred to as a ply layup. As discussed in connection with FIG. 1, for composite plies each ply may be cut such that the fibres extend in a predetermined direction. FIG. 3c shows particularly a conventional mould tool, with mould tools according to the present invention differing at least in the shape of the mould cavity.

At step 202 the mould tool is closed, by sandwiching the middle section 302 between a top section 303 and a bottom section 304 as shown in FIG. 3d. Closing the mould tool seals the layers 301 within the mould cavity.

At step 203 the mould tool is heated and compressed, with FIG. 3e showing a suitable apparatus for heating and applying compressive force to the mould tool. This compresses the layers 301 and bonds them together as the polymer softens or melts. When the mould tool is opened a blank part 306 is removed as shown in FIG. 3f. The shape of the blank part is defined by the shape of the mould cavity.

FIG. 3g shows the end product, in this case a bone fracture plate 307, after various post-moulding processes have been applied (for instance machining down the edges of the blank 306 and milling screw holes.

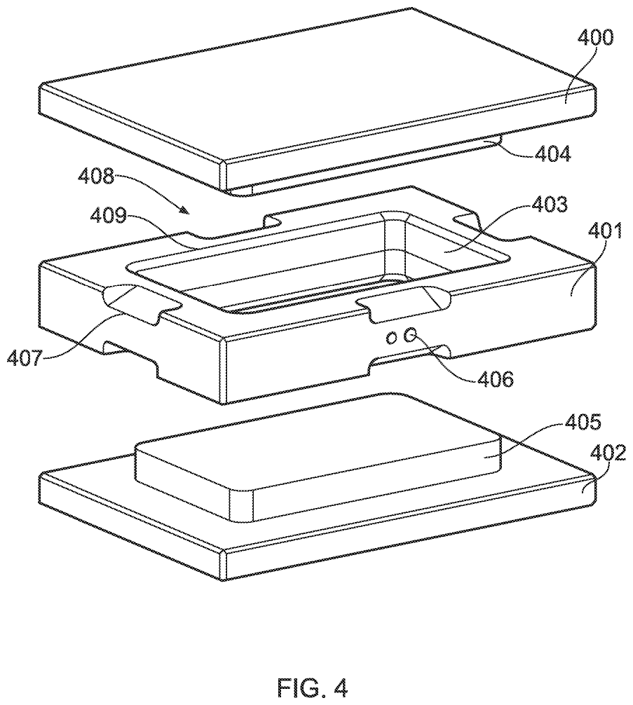

Referring now to FIGS. 4 to 8, a conventional floating three-part mould tool will now be described. Turning first to FIG. 4, the mould tool comprises a top section 400, a middle section 401 and a bottom section 402 that collectively define a mould cavity 408. A mould opening 409 extends through the middle section 401 and is defined by a side wall 403. The side wall 403 defines the edges of the mould cavity 408. The top section 400 includes a protrusion 404 that is shaped to fit into an upper end of the mould opening 409. Similarly, the bottom section 402 includes a protrusion 405 that is shaped to it into a lower end of the mould opening 409. The protrusions 404, 405 define upper and lower sides or surfaces of the mould cavity 408. The fit between the mould opening 409 and the protrusions 404, 405 is selected to be close so that when joined together the protrusions are in touching contact with the side wall 403 to substantially close off the mould cavity. FIG. 4 further shows one or thermocouple holes 406 for temperature sensing during moulding and chamfers 407 distributed about the upper and lower edges of the middle section 401 to assist the user in grasping the top and bottom sections 400, 402 when assembling or disassembling the mould tool.

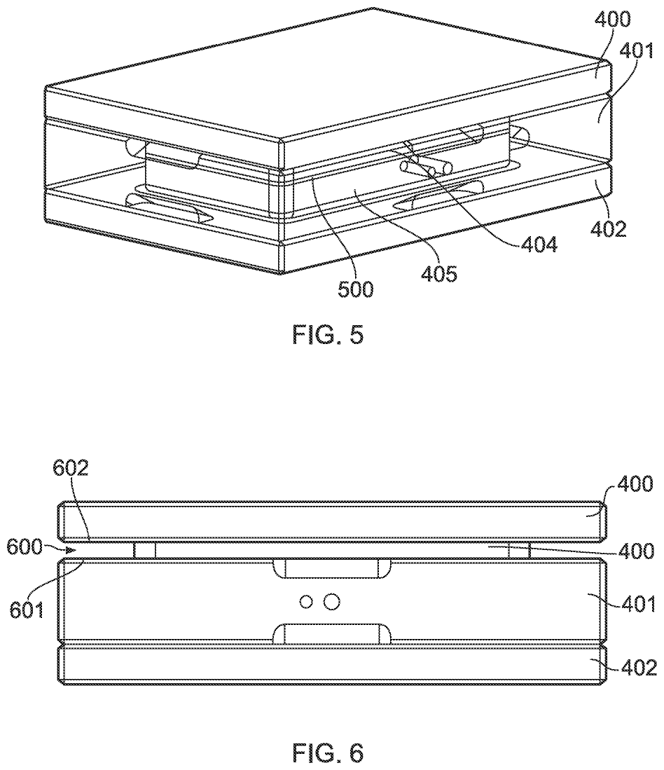

To operate the mould tool the middle and bottom sections 401, 402 may be coupled together to close off the bottom of the moulding opening 409 such that a mould cavity 408 with a closed base is defined. The layers 301 may then be stacked in the mould cavity 408 as described above and the mould cavity closed by coupling the top section 400. Turning to FIG. 5, this shows the assembled mould tool, with the middle section 401 rendered transparent so that interior detail can be seen. The stack of layers 301 has been compressed to form compression moulded blank 500 within the mould cavity 408 between protrusions 404, 405.

The side view of FIG. 6 reveals that there is a gap 600 between an upper surface 601 of the middle section 401 surrounding the mould opening 409 and a lower surface 602 of the top section 400 surrounding the protrusion 404. This gap 600 (exaggerated in FIG. 6) means that the top section 400 floats above the middle section 401 when a sufficient quantity of layers 301 are inserted into the mould cavity 408. The top section 400 floats in the sense that it does not bottom out: the surfaces 601, 602 do not meet and a gap 600 is preserved even when the maximum compressive force between the top section 400 and 401 is applied (on the assumption that a sufficient number of layers 301 is inserted in the mould cavity 408 so that even when compressed they maintain the protrusions 404, 405 sufficiently far apart).

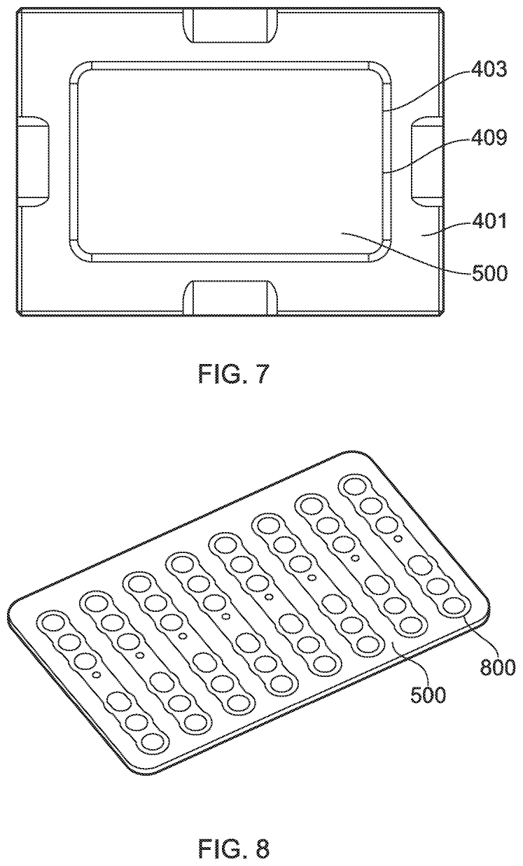

FIG. 7 shows the middle section 401 in plan view with the top section 400 removed after moulding. The compression moulded blank 500 can be seen substantially filling the mould opening 409, extending substantially to the side wall 403. FIG. 8 shows the moulded blank 500 removed from the mould tool. In this example the blank 500 is relatively large and is intended for be subdivided by cutting to form a plurality of finished articles, in this case bone fracture plates 800.

As previously mentioned, the purpose of the floating top section 400 is to ensure that the maximum compressive load is transferred to the stacked layers during compression moulding in order to reduce the incidence of voids within the moulded blank 500. The mould tool of FIGS. 4 to 7 would bottom out if an insufficient number of layers were included. However, the negative result would be a part that was too thin or not fully consolidated (that is, including voids). Accordingly, it is necessary to overfill the mould cavity so as to preserve the gap between the top and middle sections of the mould tool. This ensures that all pressure is transferred through the material within the mould tool and that the moulded blank is fully consolidated.

If the thickness of each layer or ply 301 is accurately determined or known then the thickness of the moulded blank may be accurately predicted (assuming also the degree of compression of each layer is accurately determined). However, composite tape is provided with a thickness that may vary within a known tolerance. Accordingly, the moulded blank thickness will also vary. Furthermore, because the number of layers required increases as the thickness of the moulded blank increases, the thickness tolerance also increases. In view of this thickness tolerance, the gap must be larger than the maximum expected deviation in thickness so as to ensure that the mould tool does not bottom out. If the desired thickness is not divisible by the thickness of the tape forming each layer then the desired thickness is not achievable even presuming that each layer was of its exact specified thickness. Table 1 shows the thickness tolerance for a moulded blank manufactured using a mould tool according to FIGS. 4 to 7 using a conventional tape to form each layer.

TABLE 1

| Plate Thickness | Thickness tolerance |
|---|---|
| <1.5 mm | ±0.15 mm |
| 1.5-2.5 mm | ±0.2 mm |
| 2.5-3.5 mm | ±0.25 mm |
| 3.5-4.5 mm | ±0.3 mm |
| 4.5-5.5 mm | ±0.35 mm |
| 5.5-6 mm | ±0.4 mm |

It will be appreciated that in many applications it is desirable that any thickness variation is avoided or reduced to lower levels than is achievable using a conventional mould tool. Furthermore, it may not be possible to machine down top and bottom surfaces of a moulded blank without affecting the structural integrity of the blank, particularly for composite laminate materials where this machining would cut reinforcement fibres. Furthermore, it is desirable in some applications to maintain a continuous layer on top and bottom surfaces for aesthetic reasons, and for medical implants for biocompatibility reasons.

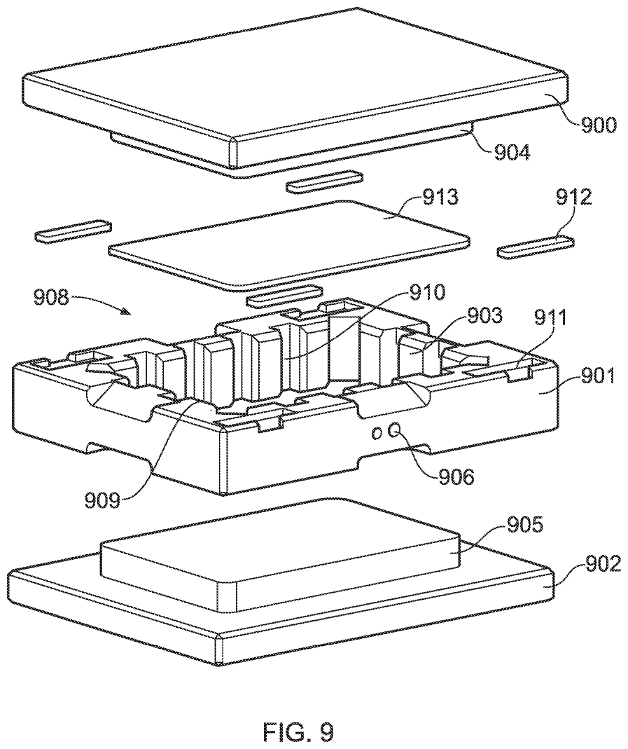

According to the present invention an improved mould tool is provided that provides for improved thickness accuracy while also ensuring a fully consolidated moulded body is formed. An example of the present invention is illustrated in FIGS. 9 to 12. FIG. 9 is a view of a three-part mould tool according to an example of the present invention and is a corresponding view to that of the conventional mould tool of FIG. 4. The differences between the two lie primarily in the side wall 903 of the mould opening 909. Corresponding parts are given the same reference number as in FIG. 4, incremented by 500. Unless otherwise stated, parts of the mould tool of FIG. 9 may be assumed to be generally similar to the description given above for FIG. 4.

FIG. 9 illustrates a three-part mould tool. As for the conventional mould tool of FIG. 4, alternatively a two-part mould tool may be used in which essentially the middle section 901 and the bottom section 902 are integrally formed.

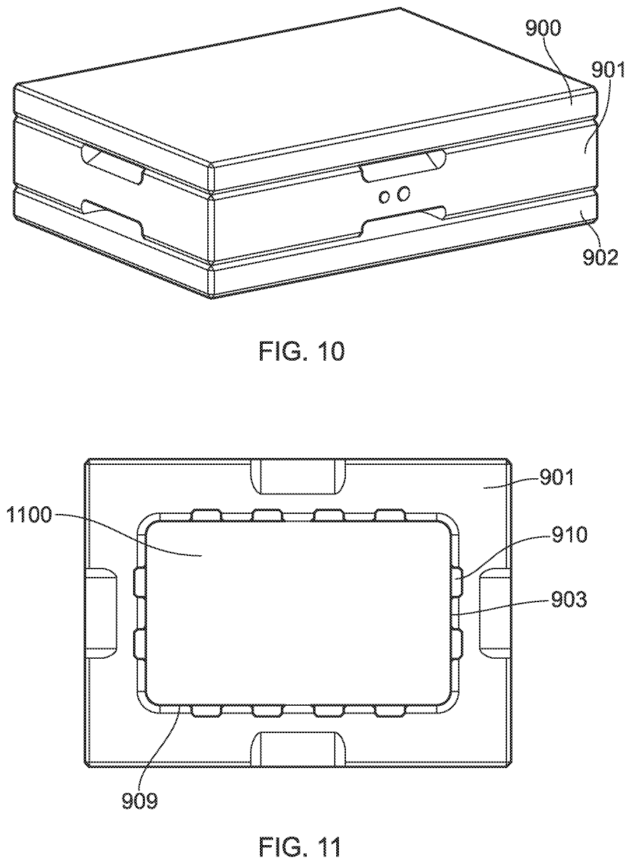

The mould tool of FIG. 9 differs from the mould tool of FIG. 4 in two key respects: firstly, the side wall 903 of the mould opening 909 includes at least one recess 910. Secondly, and as a consequence of the first difference, the mould tool is intended to bottom out. Referring to the assembled view of FIG. 10, it can be seen that no gap is preserved between the top section 900 and the middle section 901.

Under heat and pressure a polymer under compression moulding will flow. Particularly, it tends to flow laterally to the side of the mould cavity 908. For a composite material the polymer will flow preferentially perpendicular to the axis of the reinforcement fibres for each layer. For a conventional mould tool this polymer has nowhere to flow to: in order to keep the stacked layers aligned there is a close fit between the stacked layers and the side wall 403 of the mould opening. This means that the degree of compression of the stacked layers is limited, which results in the previously described thickness variation. The present inventors have identified that this property of polymer flow may be exploited by providing at least one recess 910 within the side wall 903 to accommodate the flow of polymer.

The degree of compression of the stacked layers for a conventional floating mould tool is determined by the stiffness of the moulded laminate material layers compared to the stiffness of the tool. The pressure for a floating tool is determined by a CPT (Consolidated Ply Thickness) study. Each ply has a thickness variation and so the CPT study looks at plies at each limit of the variation (that is, all thick plies versus all thin plies. Based on this, the pressure is set to achieve a consolidated part based at both limits. As the pressure is the same, as the plies vary in thickness so will the final part. For the new mould tool of FIG. 9, the applied pressure will be that required to get the tool to close, that is to bottom out. Once the tool is closed the layers cannot be compressed further therefore giving a much tighter tolerance part thickness—to ensure consolidation adequate material (perhaps an extra layer) is included within the mould cavity.

FIG. 9 shows a plurality of recesses 910 distributed about the periphery of the mould opening 909, which is better seen in the view of FIG. 11 showing the moulded blank 1100 within the mould opening 909. Accordingly, as there is a release for the polymer into a recess, under compression the stacked layers will reduce in thickness as they consolidated. If the number of layers is selected such that prior to compression the stack is thicker than the depth of the mould cavity, during compression moulding the thickness of the stack will reduce down to the depth of the mould cavity at the point the top section 900 bottoms out upon the middle section 901. Accordingly the mould cavity depth may be set to the desired thickness for the moulded blank and once a sufficient degree of compression has been applied the mould tool will bottom out and a blank with the exact desired thickness will be produced.

It will be appreciated that voids will continue to be avoided or at least reduced in incidence so long as the mould cavity is packed with a sufficient number of layers to ensure an appropriate degree of compression of the stack. As an example, the nominal thickness of a single ply is 0.14 mm. A conventional floating mould tool takes 13 plies to generate a nominal 1.70 mm thick part. Therefore each ply on average is compressed to 0.1308 mm (93.4% of the nominal uncompressed thickness). For a mould tool according to the present invention it may be desirable to achieve a similar degree of compression of each ply so that the part is fully consolidated. Accordingly, to ensure consolidation an extra 7.7% material needs to be included in the stacked layers in the mould cavity such that this excess material may be pushed out through to the recesses. The excess polymer forced laterally out of the stack will protrude from the sides of the blank into one or more recesses. However, as previously discussed, it is conventional to machine down the edges of a mould blank to nominal dimensions. Protruding polymer at recess locations can be machined off in the same process. The end result is a moulded and machined blank that is the same as for the conventional mould tool of FIG. 4, except for the thickness being more accurate (or at least less variable between repeat mouldings).

FIG. 11 shows that the recesses are substantially evenly distributed along sides of the blank 1100. In some examples recesses may also be provided in one or more corner regions. Recesses need not be even in their distribution: they may be preferentially provided where it is expected that polymer will flow from the stacked layers. This may be particularly where there is a thickness variation in the mould cavity. In some examples only a single recess may be provided. In some examples the spaces between recesses may form a majority of the circumference of the mould cavity. Or the distribution may be even, or the recesses form the majority. The spaces between the recesses continue to serve to align the stacked layers, as for the conventional mould tool

A recess may extend across the full depth of the mould cavity. Or a recess may extend for only part of the depth of the mould cavity. Each recess may be generally scalloped or curved in cross section, however substantially any shape may be used. The total volume of the recess may be configured to exceed the maximum expected flow of polymer material from the stacked layers during compression moulding. More particularly, the volume of the recesses in each part of the circumference of the mould cavity may be set to accommodate the expected flow of polymer in that region.

FIG. 9 further shows that the upper surface of the middle section 901 includes one or more slot 911, for instance four slots 911 at the corners. The slots 911 are configured to received spacers 912 which serve to increase the height of the mould cavity 908 by spacing apart the top and middle sections 900, 901 when the mould tool bottoms out. In this way, the same mould tool may be used to form moulded parts with different, accurately determined thickness by inserting spacers and adjusting the number of layers stacked into the mould cavity 908. Similarly, FIG. 9 shows a spacer 913 to fit into the mould cavity 908 underneath the top section 900 in order to form a thinner moulded part.

It will be appreciated that the dimensions of the mould tool may vary widely to manufacture moulded blanks with thicknesses in the ranges of Table 1, or thicker sill. Typically the middle section 900 may be upwards of 20 mm thick with the protrusions 904, 905 being approximately 10 mm thick. The protrusion 904 on the top section 900 may include a 5 mm thick taper at its distal end, the taper being for instance 3° and matching a corresponding taper for the mould opening 909 to aid release of the moulded blank. The number of layers or plies will vary according to the set thickness of the mould cavity 908 but may for instance be in the range of 5-15 plies, for instance 11 or 12 plies. Typically, according to examples of the present invention a moulded blank may vary from a single ply, that is approximately 0.130 mm after compression up to a typical upper limit of 10 mm for an implanted medical device. In some examples, the present invention might be used to mould parts varying between 1 mm and 6 mm. The specific mould tool illustrated herein could be used to give a thinnest plate thickness of 0.051″ (1.30 mm) with no spacers. Spacers may be used to create parts 0.059″ (1.499 mm) and 0.064″ (1.626 mm) thick. Furthermore, supplementary spacers could be used to give more size options, and the illustrated mould tool would accommodate part thicknesses from 0.051″ to 0.366″ (9.30 mm) by adding spacers varying in thickness from 0.079″ to 0.287″. Increasing the height of the middle section would allow for further thickness increases beyond 0.366″.

As noted above, the polymer in each of the stacked layers may comprise a polyaryletherketone. A polyaryletherketone may have repeating units of formula (I) below:

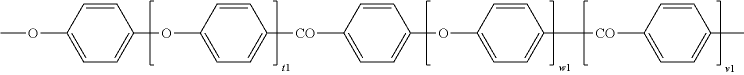

where t1 and w1 are independently represent 0 or 1 and v1 represents 0, 1 or 2.

The polyaryletherketone suitably includes at least 90, 95 or 99 mol % of repeat unit of formula I. The polyaryletherketone suitably includes at least 90, 95 or 99 weight % of repeat unit of formula I.

The polyaryletherketone may comprise or consist essentially of a repeat unit of formula I. Preferred polymeric materials comprise (or consist essentially of) a said repeat unitwherein t1=1, v1=0 and w1=0; t1=0, v1=0 and w1=0; t1=0, w1=1, v1=2; ort1=0, v1=1 and w1=0. More preferably, the polyaryletherketone comprises (e.g. consists essentially of) the repeat unit I, wherein t1=1, v1=0 and w1=0; or t1=0, v1=0 and w1=0. The most preferred polyaryletherketone comprises (especially consists essentially of) a said repeat unit wherein t1=1, v1=0 and w1=0.

The polyaryletherketone may suitably be selected from a group including polyetheretherketone, polyetherketone, polyetherketoneetherketoneketone and polyetherketoneketone. According to examples of the present invention, the polymer is particularly polyetheretherketone (PEEK).

The polyaryletherketone may have a Notched Izod Impact Strength (specimen 80 mm×10 mm×4 mm with a cut 0.25 mm notch (Type A), tested at 23° C., in accordance with ISO180) of at least 4 KJm⁻², preferably at least 5 KJm⁻², more preferably at least 6 KJm⁻². The Notched Izod Impact Strength, measured as mentioned above, may be less than 10 KJm⁻², suitably less than 8 KJm⁻². The Notched Izod Impact Strength, measured as mentioned above, may be at least 3 KJm⁻², suitably at least 4 KJm⁻², preferably at least 5 KJm⁻². The impact strength may be less than 50 KJm⁻², suitably less than 30 KJm⁻².

The polyaryletherketone (e.g. PEEK) suitably has a melt viscosity (MV) of at least 0.06 kNsm⁻², preferably has a MV of at least 0.09 kNsm⁻², more preferably at least 0.12 kNsm⁻². The polyaryletherketone (e.g. PEEK) may have a MV of less than 1.00 kNsm⁻², preferably less than 0.5 kNsm⁻².

The polyaryletherketone (e.g. PEEK) may have a MV in the range 0.09 to 0.5 kNsm⁻², preferably in the range 0.1 to 0.3 kNsm⁻², preferably having a MV in the range 0.1 to 0.2 kNsm⁻². An MV of 0.15 kNsm⁻² has been found to be particularly advantageous. MV is suitably measured using capillary rheometry operating at 400° C. at a shear rate of 1000 s⁻¹ using a tungsten carbide die, 0.5 mm×3.175 mm.

In a preferred embodiment, the polyaryletherketone (e.g. PEEK) has a melt viscosity (MV) of 0.09 kNsm⁻² to 0.5 kNsm⁻².

The polyaryletherketone may have a tensile strength, measured in accordance with ISO527 (specimen type 1 b) tested at 23° C. at a rate of 50 mm/minute of at least 20 MPa, preferably at least 60 MPa, more preferably at least 80 MPa. The tensile strength is preferably in the range 80-110 MPa, more preferably in the range 80-100 MPa.

The polyaryletherketone may have a flexural strength, measured in accordance with ISO178 (80 mm×10 mm×4 mm specimen, tested in three-point-bend at 23° C. at a rate of 2 mm/minute) of at least 50 MPa, preferably at least 100 MPa, more preferably at least 145 MPa. The flexural strength is preferably in the range 145-180 MPa, more preferably in the range 145-164 MPa. The polyaryletherketone may have a flexural modulus, measured in accordance with ISO178 (80 mm×10 mm×4 mm specimen, tested in three-point-bend at 23° C. at a rate of 2 mm/minute) of at least 1 GPa, suitably at least 2 GPa, preferably at least 3 GPa, more preferably at least 3.5 GPa. The flexural modulus is preferably in the range 3.5-4.5 GPa, more preferably in the range 3.5-4.1 GPa.

The polyaryletherketone may be amorphous or semi-crystalline. The polyaryletherketone is preferably crystallisable. The polyaryletherketone may be semi-crystalline. The level and extent of crystallinity in a polymer may be measured by wide angle X-ray diffraction (also referred to as Wide Angle X-ray Scattering or WAXS), for example as described by Blundell and Osborn (Polymer 24, 953, 1983). Alternatively, crystallinity may be assessed by Differential Scanning Calorimetry (DSC).

The level of crystallinity of said polyaryletherketone may be at least 1%, suitably at least 3%, preferably at least 5% and more preferably at least 10%. In especially preferred embodiments, the crystallinity may be greater than 25%. It may be less than 50% or less than 40%. The main peak of the melting endotherm (Tm) of said polyaryletherketone (if crystalline) may be at least 300° C.

The main peak of the melting endotherm (Tm) of the polyaryletherketone (if crystalline) may be at least 300° C. Where e.g. PEEK is used, the main peak of the melting endotherm (Tm) may be at least 300° C.

Where each layer comprises a composite material, the composite material may comprise any suitable amount of the polyaryletherketone (e.g. PEEK). For example, the composite material may comprise at least 20 volume %, preferably at least 25 volume %, more preferably at least 30 volume %, yet more preferably at least 35 volume %, even more preferably at least 37 volume % and most preferably at least 39 volume % polyaryletherketone (e.g. PEEK). The composite material comprises up to 48 volume % polyaryletherketone (e.g. PEEK). In some embodiments, the composite material may comprise up to 45 volume %, up to 43 volume % polyaryletherketone (e.g. PEEK).

In some embodiments, the composite material may comprise 20 to 48 volume %, preferably 30 to 48 volume %, more preferably 35 to 48 volume %, yet more preferably 37 to 48 volume % or 38 to 48 volume % polyaryletherketone (e.g. PEEK). More preferably, the composite material may comprise 39 to 48 volume %, even more preferably 39 to 45 volume % polyaryletherketone (e.g. PEEK). In some embodiments, the composite material may comprise 39 to 43 volume % polyaryletherketone (e.g. PEEK).

The composite material may additionally comprise of additives in the matrix. Particularly for medical applications, an example of additive includes bioactive agents, such as hydroxyapatite, or an image contrast agent, such as barium sulphate. In some examples, the composite material may comprise an image contrast agent. The image contrast agent may be present in all the layers or in selected layers of the composite material. The contrast agent may be an X-ray detectable material. For example, the contrast agent may be barium sulphate.

Any suitable reinforcement fibre may be used. The fibres used may be selected from inorganic or organic fibrous materials. The fibres may have a melting or decomposition temperature of greater than 200° C., for example, greater than 250° C. or greater than 300° C. In some embodiments, the fibres may have a melting temperature of greater than 350° C. or 500° C. Examples of suitable fibres include aramid fibres, carbon fibre, glass fibre, carbon fibre, silica fibre, zirconia fibre, silicon nitride fibre, boron fibre and potassium titanate fibre. Most preferred fibres are carbon fibres.

The volume ratio of reinforcement fibre to polyaryletherketone (e.g. PEEK) is 1.1:1 to 1.5:1, for example, 1.2:1 to 1:4:1.

The reinforcement fibre (e.g. carbon fibre) may have a tensile strength of greater than 4200 MPa, preferably greater than 4500 MPa, more preferably greater than 4800 MPa.

The reinforcement fibre (e.g. carbon fibre) may have a tensile modulus of greater than 200 GPa, preferably greater than 230 GPa, more preferably greater than 240 GPa.

The reinforcement fibre (e.g. carbon fibre) may have a strain at failure of greater than 1.1%, preferably, greater than 1.2%, 1.4% or 1.6% The reinforcement fibre (e.g. carbon fibre) may have a strain at failure of less than 2.2%, for instance, less than 2.0% or 1.9%. In some embodiments, reinforcement fibre (e.g. carbon fibre) may have a strain at failure of 1.2 to 2.2%, for example, 1.4 to 2.0% or 1.6 to 1.9%. In one embodiment, the reinforcement fibre (e.g. carbon fibre) may have a strain at failure of 1.7 to 1.9%.

The reinforcement fibre (e.g. carbon fibre) may have a mass per unit length of 0.1 to 1.0 g/m, for example, 0.2 to 0.8 g/m. In some embodiments, the mass per unit length is 0.2 to 0.5 g/m.

The reinforcement fibre (e.g. carbon fibre) may have a density of greater than 1.65 g/cm³, preferably greater than 1.70 g/cm³. The reinforcement fibre (e.g. carbon fibre) may have a density of less than 1.85 g/cm³, preferably less than 1.80 g/cm³. In some embodiments, the reinforcement fibre (e.g. carbon fibre) may have a density of 1.70 to 1.85 g/cm³, for example, 1.75 to 1.80 g/cm³, or 1.78 to 1.79 g/cm³.

The reinforcement fibre (e.g. carbon fibre) may be provided in the form of a continuous tow. Any suitable tow size may be used. The tow size indicates the number of filaments in the tow. In some embodiments, the tow size may be 1000 to 24,000. In one embodiment, a tow size of 6000 to 12,000 may be employed.

Examples of suitable reinforcement fibre include carbon fibres supplied, for example, by Hexcel® under the trademark HexTow®.

The reinforcement fibre (e.g. carbon fibre) may be present in an amount of 30 to 68 volume %, preferably 40 to 65 volume %. Preferably, the reinforcement fibre may be present in an amount of 50 to 62 volume %, for instance, 52 to 58 volume % based on the total volume of the composite material.

The reinforcement fibre (e.g. carbon fibre) may be formed into filaments. Any suitable method may be employed. For example, the reinforcement fibres may be twisted or braided to form filaments. Where the composite material is formed into tape, the filaments may be substantially aligned along the longitudinal axis of the tape.

The amount of reinforcement fibre (e.g. carbon fibre) in the composite material can be controlled within a narrow range to enable the composite material to provide an optimised balance of mechanical properties.

In some embodiments, the composite material also comprises a contrast agent, e.g. barium sulphate. For example, barium sulphate may be present in the composite material in an amount of 2 to 20 weight % of the total weight of the composite material, for instance, 3 to 10 weight %. In a preferred embodiment, the amount of barium sulphate may be 4 to 8 weight %, more preferably 4 to 6 weight %. In a most preferred embodiment, the amount of barium sulphate may be 5 weight %.

By using controlled amounts of the reinforcement fibre (e.g. carbon fibre) in combination with contrast agent, e.g. barium sulphate, it may also be possible to vary the properties of the composite material in terms of its imageability under e.g. X-ray. For example, while barium sulphate may provide sufficient radio-opacity for an implantable device to be detected under e.g. X-ray, the amount of reinforcement fibre (e.g. carbon fibre) is controlled within narrow limits to provide or maintain sufficient translucency to allow the fracture in the underlying bone to be detected under imaging techniques e.g. X-ray.

Moreover, by using controlled amounts of the reinforcement fibre (e.g. carbon fibre) in combination with barium sulphate, the radio-translucency of the composite material may be optimized to reduce interference, such that dosing accuracy during radiotherapy can be maintained.

Any suitable contrast agent may be employed. Preferably, the contrast agent is detectable by X-ray. In some embodiments, the contrast agent comprises barium. For instance, the contrast agent may be barium sulphate.

Barium sulphate is a contrast medium that allows the composite material to be detected under imaging techniques, for example, X-ray. Accordingly, when the composite material is used in the manufacture of an implantable device, the device may be detected under e.g. X-ray.

The barium sulphate may have a D₁₀ particle size in the range of 0.1 to 1.0 microns; a D₅₀ particle size in the range of 0.5 to 2.0 microns and a Do particle size in the range of 1.0 to 5 microns. The D₁₀ particle size may be in the range of 0.1 to 0.6 microns, preferably 0.2 to 5 microns. The D₅₀ particle size may be in the range of 0.7 to 1.5 microns, preferably 0.8 to 1.3 microns. The Do particle size may be in the range of 1.5 to 3 microns, preferably in the range of 2.0 to 2.5 microns.

Suitable X-ray grade barium sulphate may be available from Merck-Millipore®.

Any suitable amount of contrast agent e.g. barium sulphate may be used. For example, contrast agent e.g. barium sulphate may be present in the composite material in an amount of 2 to 20 weight %, preferably, 3 to 15 weight %, for instance, 3 to 10 weight %. In a preferred embodiment, the amount of contrast agent e.g. barium sulphate may be 3 to 8 weight %, more preferably 3 to 5 or 4 to 6 weight %. In a most preferred embodiment, the amount of contrast agent e.g. barium sulphate may be 5 weight %.

The amount of contrast agent e.g. barium sulphate may be controlled, such that the radio-translucency of the composite material is optimized to reduce interference. This can allow dosing accuracy during radiotherapy to be maintained.

Furthermore, by controlling the relative amounts of the reinforcement fibre (e.g. carbon fibre) to barium sulphate, it may also be possible to vary the properties of the composite material in terms of its imageability under e.g. X-ray. For example, the relative amounts of the reinforcement fibre (e.g. carbon fibre) to barium sulphate may be controlled to allow the implantable device to be detected under e.g. X-ray, while maintaining sufficient translucency to allow the fracture in the underlying bone to be detected.

Moreover, the relative amounts of the reinforcement fibre (e.g. carbon fibre) to barium sulphate may be controlled, such that the radio-translucency of the composite material is optimized to reduce interference. This can allow dosing accuracy during radiotherapy to be maintained.

The composite material may be formed as tape. For example, the reinforcement fibre (e.g. carbon fibre) may be combined with the polyaryletherketone (e.g. PEEK) and formed into a tape. A plurality of tapes may be joined to form a layer and the layers compression moulded to form the compression moulded body portion of the device. In an embodiment, the polyaryletherketone (e.g. PEEK) may be heated to above its softening or melting temperature to melt or soften the polymer around the fibres to form the composite. The molten or soften polymer is then compressed around the fibres.

When heat is applied, suitable temperatures include temperatures of 320° C. and above, preferably, of 330° C. and above, more preferably, of 340° C. and above. In some embodiments, compression moulding may be carried out at temperatures of 320 to 450° C., preferably 330 to 400° C., more preferably 340 to 380° C. and yet more preferably 350 to 370° C. Suitably, pressures of at least 1.5 MPa or at least 2 MPa may be applied. Examples of suitable pressures range from 1.5 to 10 MPa, for instance, 2 to 8 MPa.

The tape or layer formed using the composite material of the present invention may have a thickness of 10 microns to 1 mm, preferably 100 to 300 microns, more preferably 140 to 200 microns.

Throughout this specification, the words “comprise” and “contain” and variations of them mean “including but not limited to”, and they are not intended to (and do not) exclude other components, integers or steps. Throughout this specification, the singular encompasses the plural unless the context otherwise requires. In particular, where the indefinite article is used, the specification is to be understood as contemplating plurality as well as singularity, unless the context requires otherwise. Throughout this specification, the term “about” is used to provide flexibility to a range endpoint by providing that a given value may be “a little above” or “a little below” the endpoint. The degree of flexibility of this term can be dictated by the particular variable and can be determined based on experience and the associated description herein.

Features, integers or characteristics described in conjunction with a particular aspect or example of the invention are to be understood to be applicable to any other aspect or example described herein unless incompatible therewith. All of the features disclosed in this specification, and/or all of the steps of any method or process so disclosed, may be combined in any combination, except combinations where at least some of such features and/or steps are mutually exclusive. The invention is not restricted to the details of any foregoing examples. The invention extends to any novel feature or combination of features disclosed in this specification. It will be also be appreciated that, throughout this specification, language in the general form of “X for Y” (where Y is some action, activity or step and X is some means for carrying out that action, activity or step) encompasses means X adapted or arranged specifically, but not exclusively, to do Y.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The reader's attention is directed to all papers and documents which are filed concurrently with or previous to this specification in connection with this application and which are open to public inspection with this specification, and the contents of all such papers and documents are incorporated herein by reference.

1. A mould tool for forming a compression moulded body from a plurality of stacked layers of polymer material, the mould tool comprising:
a first section having a mould opening defined by a side wall and configured to receive the stacked layers; and
a top section configured to close the mould opening to form a mould cavity;
wherein the moulding opening side wall includes at least one recess to accommodate polymer material from the stacked layers when the stacked layers are compressed by movement of the top section towards the first section.

2. A mould tool according to claim 1, wherein the top section comprises a protrusion shaped to be received in the opening.

3. A mould tool according to claim 1, wherein the first section comprises a middle section and a bottom section;
wherein the mould opening extends through the middle section, the top section being configured to close off a first end of the mould opening; and
wherein the bottom section is configured to close off a second end of the mould opening to form the mould cavity.

4. A mould tool according to claim 3, wherein the bottom section comprises a protrusion shaped to be received in the mould opening.

5. A mould tool according to claim 1, wherein the recess extends along the side wall along the height of the mould cavity.

6. A mould tool according to claim 1, wherein the recess comprises a scallop formed in the side wall.

7. A mould tool according to claim 1, wherein the side wall comprises a plurality of spaced apart recesses.

8. A mould tool according to claim 7, wherein a greater number of recesses are distributed in regions of the side wall where the mould cavity is taller.

9. A mould tool according to claim 1, wherein the first section includes at least one slot in an upper surface facing a portion of the top section and arranged to receive a first spacer element such that the first spacer element protrudes above the upper surface and movement of the top section towards the first section is limited and the height of the mould cavity is increased.

10. A mould tool according to claim 1, further comprising a second spacer element arranged to be received in the mould opening such that the height of the mould cavity is reduced.

11. A method of manufacturing a compression moulded body, the method comprising:
providing a mould tool according to claim 1;
forming a plurality of layers of polymer material;
stacking the plurality of layers within the mould opening;
closing the mould opening with the top section; and
compressing the mould tool such that the top section moves towards the first section of the mould tool to compression mould the stacked plurality of layers within the mould cavity.

12. A method of manufacturing according to claim 11, wherein movement of the top section towards the first section is limited by part of the top section bearing against part of the first section.

13. A method of manufacturing according to claim 11, further comprising heating the mould cavity.

14. A method of manufacturing according to am claim 11, wherein the side wall of the mould opening, other than the recess, bears against portions of the plurality of layers to keep the stacked layers aligned within the mould cavity.

15. A method of manufacturing according to am claim 11, further comprising removing the compression moulded body from the mould cavity and cutting away one or more edge parts corresponding to a recess.

16. A method of manufacturing according to am claim 11, wherein the polymer is polyaryletherketone.

17. A method of manufacturing according to claim 16, wherein the polyaryletherketone is polyetheretherketone, PEEK.

18. A method of manufacturing according to claim 11, wherein the plurality of layers further includes a reinforcement fibre.

19. A method of manufacturing according to claim 18, wherein the reinforcement fibre is carbon fibre.
